(19) United States
(12) Patent Application Publication
(10) Pub. No.: US 2002/0198044 A1
(43) Pub. Date: Dec. 26, 2002

(54) Method and apparatus for facilitating a secondary wager at a slot machine

(76) Inventors: Jay S. Walker, Ridgefield, CT (US); Geoffrey M. Gelman, Stamford, CT (US); Stephen C. Tulley, Fairfield, CT (US); Michael D. Downs, Stamford, CT (US)

Correspondence Address: Michael D. Downs, Walker Digital, LLC, Five High Ridge Park, Stamford, CT, 06905, US

(21) Appl. No.: 10/121,251

(22) Filed: Apr. 11, 2002

Related U.S. Application Data
(60) Provisional application No. 60/283,082, filed on Apr. 11, 2001.

(51) Int. Cl. G06F 17/00; A63F 9/24

(52) U.S. Cl. 463/25

(57) ABSTRACT

According to one embodiment of the present invention, a method is provided for receiving a wager for a secondary game at a gaming device that offers a primary game, in which the wager indicates at least one parameter corresponding to a potential outcome of the secondary game; determining an outcome of the secondary game; and providing a payout for the secondary game.

This application claims the benefit of commonly-owned, co-pending U.S. Provisional Patent Application Serial No. 60/283,082, filed Apr. 11, 2001, entitled “Gaming Device and Methods of Operation Therefor”; incorporated herein by reference in its entirety for all purposes.

### RELATED APPLICATIONS

This application is related to commonly-owned, co-pending U.S. Patent Application Serial No. 10/023,149, filed Dec. 18, 2001, entitled “An Electronic Gaming Device Offering a Game of Knowledge for Enhanced Payouts”; and commonly-owned, co-pending U.S. patent application Ser. No. 09/722,761, filed Nov. 27, 2000, entitled “Method and Apparatus for Directing a Game with User-Selected Elements”; all of which applications are incorporated herein by reference in their entirety for all purposes.

### FIELD OF THE INVENTION

The present invention relates to methods and apparatus for facilitating a secondary wager at a gaming device, such as a slot machine. More specifically, the present invention relates to facilitating a secondary wager at a gaming device based on a prediction by a player.

### BACKGROUND OF THE INVENTION

Casino owners and operators face high levels of competition. Although casino gaming previously was available in only a limited number of jurisdictions, casino patrons now have several choices when electing where to play.

Since casino profits are directly proportional to the amount wagered by patrons, casinos are highly motivated to expand and retain share within their given market. A vast majority of casino revenues and profits are derived from patrons who elect to place wagers via slot machines. Thus, casino owners and operators are particularly motivated to draw upon players and would-be players of slot machines as a means of increasing profit levels.

U.S. Patent Application Serial No. 10/023,149, entitled “An Electronic Gaming Device Offering a Game of Knowledge for Enhanced Payouts” describes, in some embodiments, a game device and methods of operation that incorporate a game of skill, such as a trivia game, to the typical slot machine experience. According to certain embodiments, the trivia game may be conducted at the machine while the machine executes a slot machine game. For example, a player of the disclosed machine may be asked to answer a trivia question while the reels of the machine are in motion. According to some embodiments, a player performing well in relation to the trivia game may become privy to increased chances of winning a payout in the slot game.

### BRIEF DESCRIPTION OF THE DRAWINGS

FIG. 1 is a block diagram illustrating an example system according to some embodiments of the present invention.

FIG. 2 is a block diagram illustrating an example of a controller 102 as depicted in FIG. 1 according to some embodiments of the present invention.

FIG. 3 is a block diagram illustrating an example of a gaming device 106 as depicted in FIG. 1 according to some embodiments of the present invention.

FIG. 4 is a table illustrating an example data structure of an example player database 208 as depicted in FIG. 2 for use in some embodiments of the present invention.

FIG. 5 is a table illustrating an example data structure of an example gaming devices database 210 as depicted in FIG. 2 for use in some embodiments of the present invention.

FIG. 6 is a table illustrating an example data structure of an example secondary game payout database 212 as depicted in FIG. 2 for use in some embodiments of the present invention.

FIG. 7A is a table illustrating an example data structure of an example secondary game probability database 214 as depicted in FIG. 2 for use in some embodiments of the present invention.

FIG. 7B is a table illustrating an example data structure of another example secondary game probability database 214 as depicted in FIG. 2 for use in some embodiments of the present invention.

FIG. 8 is a table illustrating an example data structure of an example secondary game summary database 216 as depicted in FIG. 2 for use in some embodiments of the present invention.

FIG. 9 is a table illustrating an example data structure of an example primary game payout database 318 as depicted in FIG. 3 for use in some embodiments of the present invention.

FIG. 10 is a table illustrating an example data structure of an example primary game probability database 320 as depicted in FIG. 2 for use in some embodiments of the present invention.

FIG. 11 is a flow diagram illustrating an exemplary process for facilitating a secondary wager at a gaming device according to and for use in some embodiments of the present invention.

### DETAILED DESCRIPTION OF THE INVENTION

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

Various embodiments of the present invention operate to provide a secondary game of chance in conjunction with a primary game, such as a reel slot machine game. In some embodiments, the secondary game of chance may be based on player input. For example, player input may indicate a prediction by the player regarding the outcome of the secondary game.

Applicants have recognized that a need exists for systems and methods that help casinos and other operators of gaming devices to acquire new players, retain current players, and increase the profitability of gaming devices. One benefit of embodiments of the present invention is that they allow for more involvement of a player in play of a gaming device than is typical, and thus provide a more entertaining and experience for the player. For example, some embodiments of the present invention allow a player to place a side bet on the outcome of a slot machine spin. In other words, beyond receiving a payout for a predefined winning outcome, embodiments of the present invention provide the player with the opportunity to enhance his gaming experience by receiving a payout if the player accurately predicts various aspects of the outcome of a slot machine game, such as the occurrence of specific reel symbols or cards.

Another benefit of embodiments of the present invention is that the embodiments allow a player to be creative in customizing and/or selecting his secondary wagers at a gaming device. Yet another benefit of embodiments of the present invention is that the casino is able to determine probabilities and payouts for various secondary wagers. Further, the systems of the present invention allow a player to receive offers for secondary wagers that are based on information about the player and/or information about the player's gaming experience, so the player is more likely to accept the offer. Further, the systems of the present invention allow a player to place a secondary wager associated with one or more gaming devices and/or one or more players. Thus, a player may be encouraged to play a gaming device offering the opportunity for more interactive gaming in accordance with embodiments of the present invention.

A. Definitions

The term “gaming device” shall refer to any gaming machine, including, for example, slot machines, video poker machines, video bingo machines, video keno machines, video lottery machines, and video blackjack machines, that may or may not be capable of dispensing value in the form of cash, credit, and/or gambling tokens. “Gaming device” shall also refer to any device operable to offer a game of chance, such as a personal computer, set-top box, PDA, online gaming system or device in communication with an online gaming system, cell phone, or wireless device, and that may or may not be capable of dispensing value in the form of cash, credit, and/or gambling tokens.

A gaming device may include hardware, software, or both, to support the operations of the present invention in addition to the hardware and/or software used to perform any primary functions of the gaming device. Alternatively, a gaming device may not include any hardware and/or software to support operations of the present invention except to merely receive and respond to a signal from a controller, for example, directing the gaming device to dispense a payout and/or to display information.

The term “secondary game” shall refer to any game of chance in which a player may determine, characterize, predict, elect, specify, select, approve, accept, indicate, qualify, designate, define, describe, register a preference for, and/or identify one or more parameters of (or one or more criteria for) a potential outcome. An outcome of a secondary game is compared to the one or more criteria (or parameters) to determine if the outcome qualifies the player for a payout (e.g., if the outcome is a “winning” outcome). Thus, a secondary game may incorporate player input, such as a prediction about an outcome, in determining the result of the secondary game.

The term “primary game” shall refer to any game of chance that is not a secondary game.

The term “secondary game outcome” or “outcome of a secondary game” shall refer to any information used to determine whether a secondary wager is successful, regardless of how the information itself is generated or otherwise determined. A secondary game outcome may comprise, for example, an outcome of a primary game, an outcome that is independent of a primary game outcome, an outcome of a bonus game, or any combination of such outcomes.

The terms “secondary wager” shall refer to any wager placed on a secondary game, and may describe or indicate a monetary amount associated with the wager, one or more parameters of an outcome, or both.

The term “primary wager” shall refer to any wager on a primary game of chance, and may describe or indicate a monetary amount associated with the primary wager.

The term “slot machine game” shall refer to any primary game offered via a gaming device, including any of various slot machine games, reel slot machine games, video poker games, video bingo games, video keno games, and video blackjack games.

The term “casino” shall refer to the owner of gaming devices, owners' agents, and/or any entity who may profit from players' use of the gaming devices.

The term “controller” shall refer to a device that may be in communication with a plurality of gaming devices, and may be capable of relaying communications to and from each.

The term “input device” shall refer to a device that is used to receive an input. An input device may communicate with or be part of another device (e.g. a point-of-display terminal, a player device, a gaming device, a controller, etc.). Some examples of input devices include: a bar-code scanner, a magnetic stripe reader, a computer keyboard, a touch-screen, a microphone, an infrared sensor, a sonic ranger, a computer port, a video camera, a digital camera, a GPS receiver, a radio frequency identification (RFID) receiver, a RF receiver, a thermometer, and a weight scale.

The term “output device” shall refer to a device that is used to output information. An output device may communicate with or be part of another device (e.g. a point-of-display terminal, a player device, a gaming device, a controller, etc.). Output devices may include, for example: a cathode ray tube (CRT) monitor, liquid crystal display (LCD) screen, light emitting diode (LED) screen, a printer, an audio speaker, an infrared transmitter, and a radio transmitter.

The term “input/output device” shall refer to any combination of input and/or output devices.

The term “player tracking card” shall refer to a device that may be capable of storing and/or indexing information about a player who is a casino player. This information may include identifying information, as well as financial information, such as a number of gambling credits remaining. The player tracking card may be machine-readable, for example, by an input device or a gaming device. The player tracking card may be machine-writable, for example, by an output device or a gaming device.

B. System

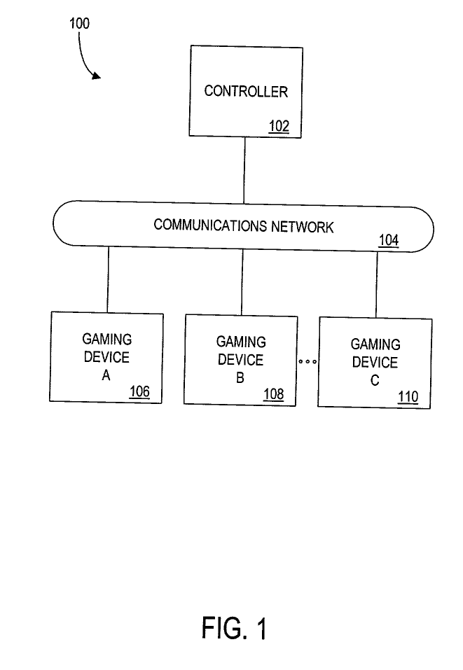

Referring now to FIG. 1, a system 100 according to some embodiments of the present invention includes a controller 102 that is in one or two-way communication via a communications network 104 with one or more gaming devices 106, 108, 110. In operation, the controller 102 may function under the control of a casino or other entity that may also control the gaming devices 106, 108, 110. For example, the controller 102 may be a slot server in a casino's gaming device network. In some embodiments, the controller and the gaming device may be one and the same.

In the embodiment pictured in FIG. 1, communication between the controller 102 and the gaming devices 106, 108, 110 may be direct and/or via a network, such as the Internet, a LAN, and/or a proprietary network.

Each of the controller 102 and the gaming devices 106, 108, 110 may comprise computers, such as those based on the INTEL PENTIUM processor, that are adapted to communicate with each other. Any number of gaming devices 106, 108, 110 may be in communication with the controller 102. The controller 102 and the gaming devices 106, 108, 110 may each be physically proximate to each other or geographically remote from each other. The controller 102 and the gaming devices 106, 108, 110 may each include input devices (not pictured) and output devices (not pictured).

As indicated above, communication between the controller 102 and the gaming devices 106, 108, 110 may be direct or indirect, such as over an Internet Protocol (IP) network such as the Internet, an intranet, or an extranet through a web site maintained by the controller 102 on a remote server or over an on-line data network including commercial on-line service providers, bulletin board systems, routers, gateways, and the like. In yet other embodiments, the devices may communicate with the controller 102 over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like. Some embodiments of the present invention thus provide for on-line gaming

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

The controller 102 may function as a “web server” that presents and/or generates web pages, which are documents stored on Internet-connected computers accessible via the World Wide Web using protocols such as, e.g., the hyper-text transfer protocol (“HTTP”). Such documents typically include one or more hyper-text markup language (“HTML”) files, associated graphics, and script files. A web server allows communication with the controller 102 in a manner known in the art. The gaming devices 106, 108, 110 may use a web browser, such as NAVIGATOR! published by NETSCAPE for accessing HTML forms generated or maintained by or on behalf of the controller 102.

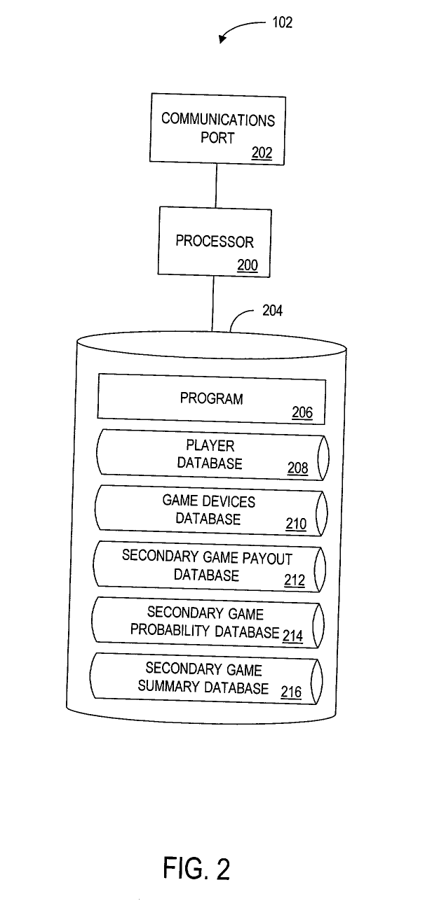

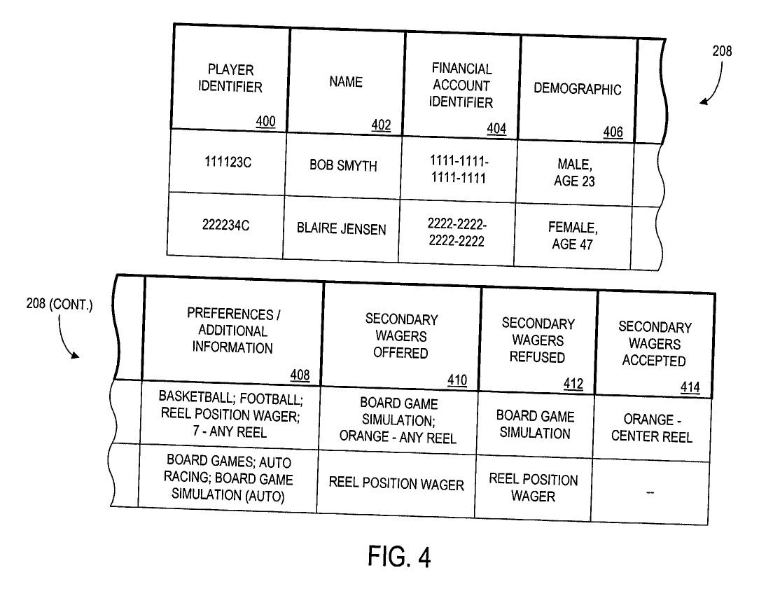

Any or all of the controller 102 and the gaming devices 106, 108, 110 may include, for example, telephones, interactive voice response (IVR) systems such as the ML400-IVR designed by MISSING LINK INTERACTIVE VOICE RESPONSE SYSTEMS, cellular/wireless phones, pagers, personal computers, and portable types of computers, such as a laptop computer, a wearable computer, a palm-top computer, a hand-held computer, and/or a Personal Digital Assistant (“PDA”). Further details of the controller 102 and the gaming devices 106, 108, 110 are provided below with respect to FIGS. 2 and 4.

As indicated above, in some embodiments of the invention the controller 102 may include gaming devices 106, 108, 110. Likewise, the controller 102 may communicate with players directly instead of through the gaming devices 106, 108, 110. Although not pictured, the controller 102 and/or the gaming devices 106, 108, 110 may also be in communication with one or more player credit institutions to effect transactions. Transactions may be effected directly or via a secure financial network such as the Fedwire network maintained by the United States Federal Reserve System, the Automated Clearing House (hereinafter “ACH”) Network, the Clearing House Interbank Payments System (hereinafter “CHIPS”), or the like.

Although only three gaming devices 106, 108, 110 are shown in FIG. 1, it should be understood that any number of gaming devices may be included in the system 100.

Generally, any of the gaming devices 106, 108, 110 includes hardware, software, or both, to support operations of the present invention, such as providing a secondary game, in addition to the hardware and/or software used to provide the primary functionality of the gaming device. For example, gaming devices 106, 108, 110 may offer a typical slot machine game, such as a three-reel game, in addition to being fitted with appropriate electronic, mechanical, software and/or electromechanical means for executing a secondary game of chance.

In some embodiments, some operations of the present invention are performed by a gaming device, and other operations are performed by the controller 102. Alternatively, gaming devices 106, 108, 110 may not include any hardware and/or software to support operations of the present invention except to merely receive and respond to a signal from the controller 102 directing the gaming device to dispense a payout.

In operation, the gaming devices 106, 108, 110 may exchange information about the player and any secondary wager(s) via the controller 102. The gaming devices 106, 108, 110 may provide information to the controller 102. The controller 102 may provide information to the gaming devices 106, 108, 110. The controller 102 also may provide various control signals to the gaming devices 106, 108, 110, directing them to present offers, display game information, generate game outcomes, provide payouts to players, etc.

C. Devices

FIG. 2 is a block diagram illustrating details of an example of the controller 102 of FIG. 1. The controller 102 is operative to manage the system and execute methods of the present invention. For example, some or all of the processes for providing a secondary game of chance may be carried out by the controller 102. The controller 102 may be implemented as one or more system controllers, one or more dedicated hardware circuits, one or more appropriately programmed general purpose computers, or any other similar electronic, mechanical, electromechanical, and/or human operated device.

The controller 102 may include a processor 200, such as one or more PENTIUM® processors manufactured by INTEL CORPORATION®. The processor 200 may include or be coupled to one or more clocks or timers (not pictured), which may be useful for determining information relating to, for example, whether a secondary wager is resolved or successful within a specified time, and one or more communication ports 202 through which the processor 200 communicates with other devices, such as the gaming devices 106, 108, 110. The communication port 202 may be a serial port, modem, wireless transmitter/receiver or the like. The processor 200 is also in communication with a data storage device 204.

The data storage device 204 includes, for example, an appropriate combination of magnetic, optical and/or semiconductor memory, and may include, for example, additional processors, communication ports, Random Access Memory (“RAM”), Read-Only Memory (“ROM”), a compact disc and/or a hard disk. The processor 200 and the storage device 204 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments, for example, the controller 102 may comprise one or more computers (or processors 200) that are connected to a remote server computer operative to maintain databases, where the data storage device 204 is comprised of the combination of the remote server computer and the associated databases.

The data storage device 204 stores a program 206 for controlling the processor 200. The processor 200 performs instructions of the program 206, and thereby operates in accordance with the present invention, and particularly in accordance with the methods described in detail herein. The present invention can be embodied as a computer program developed using an object-oriented language that allows the modeling of complex systems with modular objects to create abstractions that are representative of real world, physical objects and their interrelationships. However, it would be understood by one of ordinary skill in the art that the invention as described herein can be implemented in many different ways, using a wide range of programming techniques as well as general purpose hardware systems or dedicated controllers. The program 206 may be stored in a compressed, uncompiled and/or encrypted format. The program 206 furthermore may include program elements that may be generally useful, such as an operating system, a database management system, and “device drivers” for allowing the processor 200 to interface with computer peripheral devices.

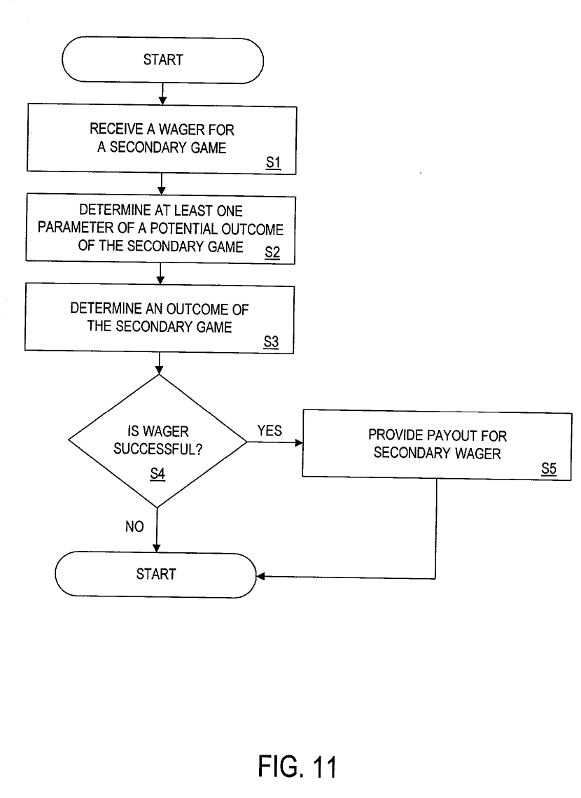

Further, the program 206 is operative to execute a number of embodiment-specific modules or subroutines including but not limited to one or more routines to identify a player at a gaming device 106, 108, 110 as a potential candidate to be offered a secondary wager; one or more routines to receive information about a player; one or more routines to offer a secondary wager to a player; one or more routines to determine if a player accepts a secondary wager; one or more routines to determine the result of a secondary wager; one or more routines to signal gaming devices 106, 108, 110 to dispense a payout if a secondary wager is successful; one or more routines to facilitate and control communications between gaming devices 106, 108, 110 and the controller 102; and one or more routines to control databases or software objects that track information regarding players, secondary wagers and gaming devices 106, 108, 110. Examples of these routines and their operation are described in detail below in conjunction with the flowchart depicted in FIG. 11.

According to some embodiments of the present invention, the instructions of the program 206 may be read into a main memory of the processor 200 from another computer-readable medium, such from a ROM to a RAM. Execution of sequences of the instructions in the program 206 causes processor 200 to perform the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

In addition to the program 206, the storage device 204 is also operative to store (i) a player database 208, (ii) a gaming devices database 210, (iii) a secondary game payout database 212, (iv) a secondary game probability database 214, and (v) a secondary game summary database 216. The databases 208, 210, 212, 214, 216 are described in detail below and example structures are depicted with sample entries in the accompanying figures.

As will be understood by those skilled in the art, the schematic illustrations and accompanying descriptions of the sample databases presented herein are exemplary arrangements for stored representations of information. Any number of other arrangements may be employed besides those suggested by the tables shown. For example, even though five separate databases are illustrated, the invention could be practiced effectively using one or more functionally equivalent databases. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention. These processes are described below in detail with respect to FIG. 11.

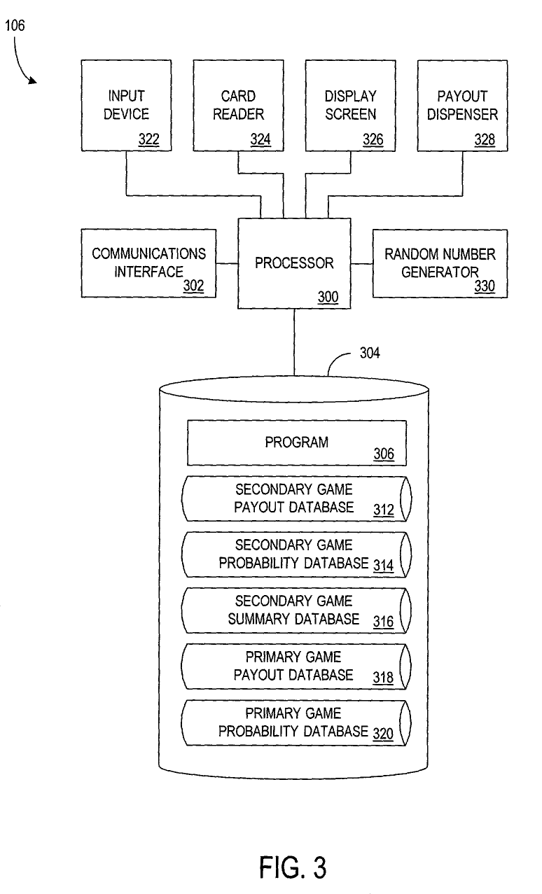

Turning to FIG. 3, a block diagram of an example gaming device 106 is depicted. A gaming device 106 according to the present invention may include a processor 300 coupled to a communication port 302, and a data storage device 304.

The communication port 302 provides one- or two-way data communications with the controller 102. For example, the communication port 302 may be embodied as a serial port, modem, wireless transmitter/receiver or the like, operative to assist the gaming device 106 in providing one- or two-way data communications with the controller 102.

The data storage device 304 includes an appropriate combination of magnetic, optical and/or semiconductor memory, and may include, for example, additional processors, communication ports, Random Access Memory (“RAM”), Read-Only Memory (“ROM”), a compact disc and/or a hard disk. The processor 300 and the storage device 304 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments, for example, the gaming device 106 may comprise one or more computers (or processors 300) that are connected to a remote server computer operative to maintain databases, where the data storage device 304 is comprised of the combination of the remote server computer and the associated databases.

The data storage device 304 stores a gaming device program 306 for controlling the processor 300. The processor 300 performs instructions of the program 306, and thereby operates in accordance with the present invention, and particularly in accordance with the methods described in detail herein. As with the program 206 of the controller 102, the program 306 may be stored in a compressed, uncompiled and/or encrypted format. The program 306 furthermore may include program elements that may be generally useful, such as an operating system, a database management system, and “device drivers” for allowing the processor 300 to interface with computer peripheral devices. Appropriate general purpose program elements are known to those skilled in the art, and need not be described in detail herein.

In accordance with the present invention, the gaming device 106, the controller 102, or both, may execute the program 306 in order to provide a secondary game of chance in accordance with various embodiments of the present invention. For example, the controller 102 may transmit a control signal to gaming device 106 to execute the program 306.

The program 306 is operative to execute a number of embodiment-specific modules or subroutines including but not limited to one or more routines to identify a player at the gaming device 106 as a potential candidate to be offered a secondary wager; one or more routines to receive information about a player; one or more routines to offer a secondary wager to a player; one or more routines to determine if a player accepts a secondary wager; one or more routines to determine one or more parameters associated with a secondary wager; one or more routines to determine the result of a secondary wager; one or more routines to signal gaming devices 106, 108, 110 to dispense a payout if a secondary wager is successful; one or more routines to facilitate and control communications between gaming devices 106, 108, 110 and the controller 103; and one or more routines to control databases or software objects that track information regarding players, secondary wagers and gaming devices 106, 108, 110. Examples of these routines and their operation are described in detail below in conjunction with the flowchart depicted in FIG. 11.

According to some embodiments of the present invention, the instructions of the program 306 may be read into a main memory of the processor 300 from another computer-readable medium, such as from a ROM to a RAM, or from data storage device 204 of the controller 102. Execution of sequences of the instructions in the program 306 causes processor 300 to perform the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

In addition to the program 306, the storage device 304 is also operative to store (i) a secondary game payout database 312, (ii) a secondary game probability database 314, (iii) a secondary game summary database 316, (iv) a primary game payout database 318, and (v) a primary game probability database 320. The databases 312, 314, 316 are similar to the databases 212, 214, 216 described above with respect to the controller 102 depicted in FIG. 2. Databases 212, 214, 216, 318, 320 are described in detail below and example structures are depicted with sample entries in the accompanying figures.

The gaming device program 306 may include one or more routines to facilitate and control communications and interaction with the controller 102, as well as a user interface to facilitate communications and interaction with a player.

A gaming device 106 according to the present invention may also include an input device 322, a card reader device 324, a display screen 326, a payout dispenser 328, and a random number generator 330.

The random number generator 330 may be used by the gaming device 106 or the controller 102 to (i) establish an outcome for a primary game, (ii) to establish an outcome for a secondary game of chance, or (iii) both. The random number generator itself may comprise any of many widely-available random or pseudo-random number generators and may be embodied as hardware, software and/or an appropriate combination thereof. According to one embodiment of the invention, the random number generation functionality of the invention may be incorporated into the program 306. In some embodiments, the random number generator is operated in response to control signals from the controller 102.

In addition, the gaming device 106 may include one or more input devices (not shown). Appropriate input devices may include, for example: (i) a currency acceptor, (ii) a player tracking card reader/writer, (iii) a printer (e.g. for printing receipts), (iv) one or more starting controllers for initiating a primary or secondary game of chance, (v) a keypad, (vi) a mouse, (vii) a security camera, etc.

In addition, the gaming device 106 may include one or more output devices (not shown). Appropriate output devices may include for example: (i) any number of reels or electronic representations thereof, (ii) a display screen, (iii) audio output such as a speaker, (iv) a hopper (i.e., coin/token dispenser) etc.

D. Databases

As indicated above, it should be noted that although the example embodiment of FIG. 2 is illustrated to include five particular databases stored in storage device 204, other database arrangements may be used which would still be in keeping with the spirit and scope of the present invention. In other words, the present invention could be implemented using any number of different database files or data structures, as opposed to the five depicted in FIG. 2. Similarly, although the example embodiment of FIG. 3 is illustrated to include five particular databases stored in storage device 304, other database arrangements may be used.

Further, the individual database files could be stored on different servers (e.g., located on different storage devices in different geographic locations). Likewise, the program 206 could also be located remotely from the storage device 204 and/or on another server. As indicated above, the program 206 includes instructions for retrieving, manipulating, storing and/or indexing data in the databases 208, 210, 212, 214, 216 as necessary to perform the methods of the invention as described below. Program 206 and program 306 could be one and the same.

1. Player Database

Turning to FIG. 4, a tabular representation of an embodiment of player database 208 according to some embodiments of the present invention is illustrated. This particular tabular representation of a player database 208 includes two sample records or entries which each include information regarding a particular player. In some embodiments of the invention, a player database 208 is used to track player information such as the player's name, financial account information, demographic description, preferences for secondary wagers, secondary wagers offered to the player, secondary wagers refused, and secondary wagers accepted. Those skilled in the art will understand that a player database 208 may include any number of records or entries.

The particular tabular representation of a player database 208 depicted in FIG. 4 defines a number of fields for each of the entries or records. The fields may include: (i) a player identifier field 400 that stores a representation identifying a particular player; (ii) a name field 402 that stores a representation of the player's name; (iii) a financial account identifier field 404 that stores a representation of a bank, credit card, debit card, or financial account number that identifies an account; (iv) a demographic field 406 that stores a representation of a description of demographic characteristics of the player for identifying players with desired characteristics to whom secondary wagers may be offered; (v) a preferences field 408 that stores a representation of a description of additional information about the player for identifying secondary games the player prefers and/or for automatically placing secondary wagers for the player (and also for identifying players with desired characteristics to whom secondary wagers may be offered); (vi) a secondary games offered field 410 that stores a representation of the secondary wagers that the player has been offered in the form of one or more secondary game type identifiers 600 and/or secondary wagers 602 (discussed below); (vii) a secondary wagers refused field 412 that stores a representation of the secondary wagers that the player has refused in the form of one or more secondary game type identifiers 600 and/or secondary wagers 602; and (viii) a secondary wagers accepted field 414 that stores a representation of the secondary wagers that the player has accepted in the form of one or more secondary game type identifiers 600 and/or secondary wagers 602.

The example player database 208 of FIG. 4 provides example data to illustrate the meaning of the information stored in this database embodiment. A player identifier 400 (e.g., 111123C, 222234C) may be used, for example, to identify and index players who have placed a wager on a secondary game. The player identifier 400 may be unique and alphanumeric, for example, but need not be either unique or alphanumeric.

The first sample entry describes a player named “Bob Smythe,” who has a credit card account number “1111-1111-1111-1111,” and is “male, age 23.” His interests include “basketball, [and] football” and he has registered a preference for “REEL POSITION WAGER”-type secondary games and a preference for a secondary wager of “7-ANY REEL”. According to the secondary wagers offered field 410, secondary wagers refused field 412, and secondary wagers accepted field 414, Bob Smythe has been offered a “BOARD GAME SIMLATION” wager and a “ORANGE-CENTER REEL” wager, of which he refused the first and accepted the second.

The second sample entry describes a player named “Blair Jensen,” who has a credit card account number “2222-2222-2222-2222,” and is “female, age 47.” Her interests include “board games, [and] auto racing” and she has registered a preference for automatically having a secondary wager placed at any gaming devices offering a “BOARD GAME SIMULATION”-type secondary game. According to the secondary wagers offered field 410, and secondary wagers refused field 412, Blair Jensen has been offered and refused a “REEL POSITION WAGER”-type secondary wager.

2. Gaming Devices Database

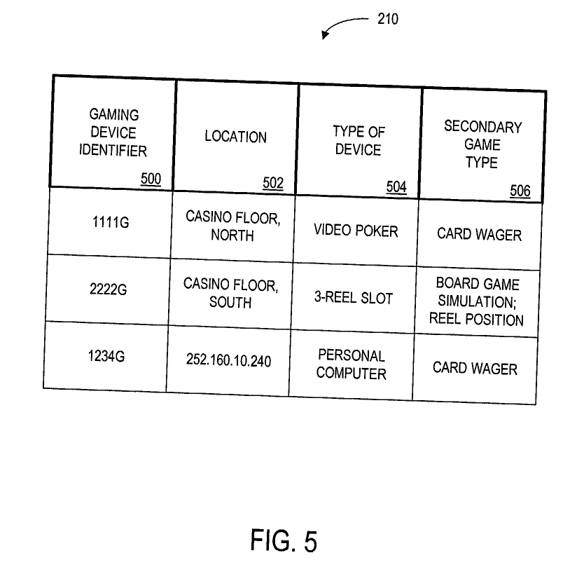

Turning to FIG. 5, a tabular representation of an embodiment of a gaming devices database 210 according to some embodiments of the present invention is illustrated. This particular tabular representation of a gaming devices database 210 includes three sample records or entries which each include information regarding a particular gaming device. In some embodiments of the invention, a gaming devices database 210 is used to track such things as the type and location of each gaming device. In some embodiments, the gaming devices database 210 is used to track such things as what secondary games may be provided at each gaming device. Those skilled in the art will understand that a gaming devices database 210 may include any number of records or entries.

The particular tabular representation of a gaming devices database 210 depicted in FIG. 5 defines a number of fields for each of the entries or records. The fields may include: (i) a gaming device identifier field 500 that stores a representation identifying at least one gaming device; (ii) a location field 502 that stores a representation identifying where the gaming device is currently located; (iii) a type of device field 504 that stores a representation of the type of gaming device; and (iv) a secondary games field 506 that stores a representation describing types of secondary games the gaming device may provide.

The example gaming devices database 210 of FIG. 5 provides example data to illustrate the meaning of the information stored in this database embodiment. A gaming device identifier 500 (e.g., 1111G, 2222G, 1234G) may be used to identify and index the different gaming devices listed in the gaming devices database 210. The gaming device identifier 500 may be unique and alphanumeric, for example, but need not be either unique or alphanumeric. The location field 502, type of device field 504, and the secondary games field 506 may provide information that allows the controller 102, for example, to choose what types of secondary wagers to offer to a player. Such information may also allow the controller 102 to direct a player to a particular gaming device. For example, a player at a first gaming device may be directed to a second gaming device that offers one or more primary or secondary games in which the player might be interested.

In the first sample entry, a “video poker” gaming device offering a “card wager”-type secondary game in which the player may predict dealt cards is located on a “casino floor, north.” In the second sample entry, a “three-reel slot machine” is located on the “casino floor, south” and offers a “board game simulation”-type secondary game, as well as a “reel position”-type secondary game in which the player can predict outcomes of reel spins.

In the third sample entry, the gaming device is a “personal computer” with an associated Internet protocol (IP) address of “252.160.10.240”. The personal computer enables the player to a “card wager”-type secondary game in which the player can wager on various parameters of outcomes, such as the hands and/or cards dealt.

3. Secondary Game Payout Database

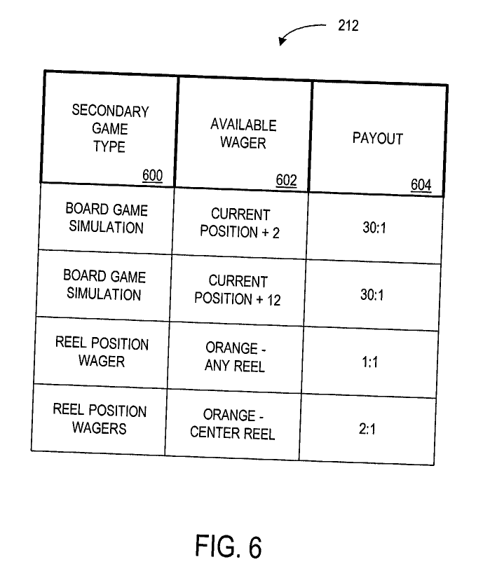

Turning to FIG. 6, a tabular representation of an embodiment of a secondary game payout database 212 according to some embodiments of the present invention is illustrated. This particular tabular representation of a secondary game payout database 212 includes sample records or entries which each include information regarding a secondary game payout for a particular secondary wager. In some embodiments of the invention, a secondary game payout database 212 is used to track such things as secondary game types, available secondary wagers, and payouts corresponding to the available secondary wagers. Those skilled in the art will understand that secondary game payout database 212 may include any number of records or entries.

The particular tabular representation of a secondary game payout database 212 depicted in FIG. 6 defines a number of fields for each of the entries or records. The fields may include: (i) a secondary game type field 600 that stores a representation of a secondary game type; (ii) a secondary wager field 602 that stores a representation of a description of a secondary wager associated with the secondary game; and (iii) a secondary game payout field 604 that stores a representation of a payout for a corresponding secondary wager.

In accordance with embodiments of the present invention, the gaming device 106 and/or the controller 102 may utilize the information stored in the secondary game payout database 212 (or database 312) in providing a payout to a player who made a successful secondary wager (e.g., the player predicted or identified one or more parameters subsequently met by the secondary game outcome).

The example secondary game payout database 212 depicted in FIG. 6 provides example data to illustrate the meaning of the information stored in this database embodiment. A secondary game type identifier 600 (e.g. “BOARD GAME SIMULATION”) may be used to identify and index the secondary games listed in the secondary game payout database 212. The secondary game type identifier 600 may be descriptive, unique, and/or alphanumeric, for example, but need not be either descriptive, unique, or alphanumeric. The secondary game type identifier may be a representation of a description of the type of game. Examples of secondary wagers are provided in the secondary wager field 602. The secondary game payout field 604 lists examples of payout ratios and/or payout amounts that may be used to determine a payout for a player if the player makes an accurate prediction for a secondary game.

The example secondary wagers have one or more corresponding parameters, or criteria, that may be used to determine whether the player wins the secondary wager. Such criteria may include, but are not limited to: a wager amount, a reel, a position, a payline, a position on a representation of a game board, a represented game piece or token, a reel symbol, a card, a payout, an event, a probability, a number of symbols, a number of positions, a number of plays, a number of spins, a number of cards, a number of hands, a number of turns or selections in a bonus round or bonus game, a time, a period of time, a number of players, a number of slot machines, an amount won, an amount lost, a game device, and a player.

Appropriate and available parameters will vary, of course, depending upon the type of secondary game on which the player is wagering. For example, for a secondary game that requires the player to predict something about the outcome of a slot machine spin, the player may indicate a symbol, a reel, or both.

In an exemplary side bet, a player indicates one or more reels of a slot machine game and a symbol that will be displayed when the reel comes to rest at one or more displayed lines. Some slot machine games, for example, display multiple lines and thus display more than one symbol for each reel. Of course, one or more symbols, and/or one or more reels, may be specified in the wager.

Another exemplary side bet indicates a reel and a position, or stop, of the reel that will be displayed when the reel comes to rest. Another exemplary side bet indicates a symbol and a position on the display screen at which the player predicts the symbol will come to rest. Another exemplary side bet indicates a symbol and at least one payline on which the symbol will appear when the reels come to rest.

In some embodiments, the player predicts an event or occurrence in the secondary game. For example, the player may predict that during a play of a slot machine game, the first reel will stop spinning last.

Some slot machines provide a representation of a board game. During play of the slot machine game, a video token moves around the game board in accordance with a simulated roll of dice. In some embodiments of the present invention, a player can make a secondary wager predicting one or more spaces on a represented game board where the token will come to rest as a result of the dice roll, or as a result of the simulated play of the board game.

For example, the player may predict that the token will come to rest at a position seven spaces from the starting position of the game token. For instance, the resting, or final, position of the game token could be seven spaces ahead (or behind) the starting position. In another example, the player can predict a type of position or game board space on which the token will come to rest. Of course, many other such predictions are possible, and the possible parameters that may be predicted will vary according to the secondary game provided.

In another example, for a secondary game in which the player predicts the next position of a game token on a representation of a board game, the player may indicate the predicted next position. In another example, the player could predict that a representation of a game token will have to move backwards, that the player will win a payout in a bonus game, or that the player will lose a bonus game.

In another example, in some bonus games a player makes one or more selections from various options, and may continue to make selections until a particular option is chosen and the bonus game ends. In such embodiments, a secondary game could be provided in which, for example, the player predicts how many selections the player will be able to make before the bonus game ends. Similarly, some bonus games allow for a player to advance along a representation of a path or board game (e.g., based on simulated dice rolls, based on spins of a wheel numbered in correspondence with a number of spaces moved) until a finish is reached or some other event ends the bonus game. In some embodiments, a secondary game could be provided in which, for example, the player predicts how many dice rolls or other turns the player will be able to take until the bonus game ends.

In other embodiments related to bonus games, the player may make a prediction as to the amount or value of a bonus prize or bonus payout. Bonus games typically award coins or credits, free spins, or payout multipliers. In a secondary wager, a player could make a prediction about, for example, the amount of a bonus payout (e.g., “100 coins”, “less than 50 coins”), a number of free spins (e.g., “5 spins”, “more than 3 spins”, or a multiplier (e.g., “5×”, “2× or 3×”).

In another example, a secondary game includes displaying video of a sports event. A player could predict an event or occurrence in the sports event, such as a score (e.g., a touchdown, a field goal), a score attempt, or a foul. In another example, a secondary game is based on a displayed video and the player can place a secondary wager on the length of the video.

In some embodiments, the player can make a prediction as to the outcome of a simulated dice roll (or roll of one die). For example, a player can predict that the dice roll will be “7”. In another example, the player can predict that the simulated dice roll will be “doubles” (e.g., two “6's”). In another example, the player can predict a value for one or more individual die (e.g., one “2”; or one “1” and one “6”).

In other embodiments, the player can make a prediction as to the outcome of a race. The race may be an electronic simulation (e.g., of race cars on a racetrack), a live video feed, or recorded video of a race. For example, the player may place a wager on the winner of the race, the loser of the race, or on any other position in the race.

In some of the embodiments, the player may elect to have the gaming device 106 pick one or more of the criteria. For example, the gaming device 106 may offer to select a reel symbol at random for the player and place a secondary wager using the random symbol as a criterion for the secondary game outcome. If the player agrees, the gaming device determines a symbol (e.g., “ORANGE”) and a reel (e.g., the leftmost reel), for example, and executes the secondary game based on the criteria. In another example, the gaming device 106 provides a reel symbol and prompts the player to predict how many of the symbol will appear anywhere in the next reel spin, in a payline in the next reel spin, or anywhere in the next five reel spins.

In some embodiments, the criteria correspond to a predicted number of plays of a primary game. For example, the player may guess how many slot machine spins it will take to have ten “CHERRY” symbols displayed, or how many hands of video poker it will take to have five aces dealt to the player.

In other embodiments, the criteria may correspond to a period of time. For example, the player may predict how long it will take to achieve one or more criteria. For instance, the player may place a secondary wager specifying that it will take less than ten minutes to get a winning outcome in a primary game. In another example, the player places a secondary wager on his guess that he will accumulate ten or more “CHERRY” reel symbols in the next five minutes.

Similarly, in other embodiments the player may make a prediction corresponding to a specified time or event. For example, the player may place a secondary wager predicting that he will win more than a specified amount, or accumulate a number of reel symbols, before a time or event (e.g., 10 p.m., the time the player checks out of his hotel, the end of a sporting event).

Numerous different example criteria are described herein with respect to secondary wagers. It will be understood that any number of criteria may be associated with a particular secondary wager, and further understood that a player may place more than one active secondary wager at one time.

In the first and second sample entries of secondary game payout database 212, the exemplary secondary game type is a “BOARD GAME SIMULATION” in which a player can place a wager (e.g., specify one or more criteria) as to which area or position on a representation of a board game a particular game piece will land when a “move” is represented. In the first sample entry, the secondary wager is based on a prediction that the game piece will come to rest at a position that is two spaces from its starting position (e.g., “CURRENT POSITION+2”), and has a corresponding payout of “30:1.” In the second sample entry, the secondary wager is based on a prediction that the game piece will land at a position that is twelve spaces from the initial position (e.g., “CURRENT POSITION+12”), and has a corresponding payout of “30: l.”

In the third and fourth sample entries, the exemplary secondary game type is a “REEL POSITION WAGER” in which a player places a wager (e.g., makes a prediction) as to at which position, or on which symbol, a particular slot machine reel will come to rest during play of a slot machine game. In the third sample entry, the secondary wager is that a play of the primary slot machine game will result in one or more “ORANGE” symbols being displayed on any reel (e.g., “ORANGE-ANY REEL”). In the fourth sample entry, the secondary wager is that a play of the slot machine game will result in an “ORANGE” symbol coming to rest anywhere on the center reel (e.g., “ORANGE-CENTER REEL”).

4. Secondary Game Probability Database

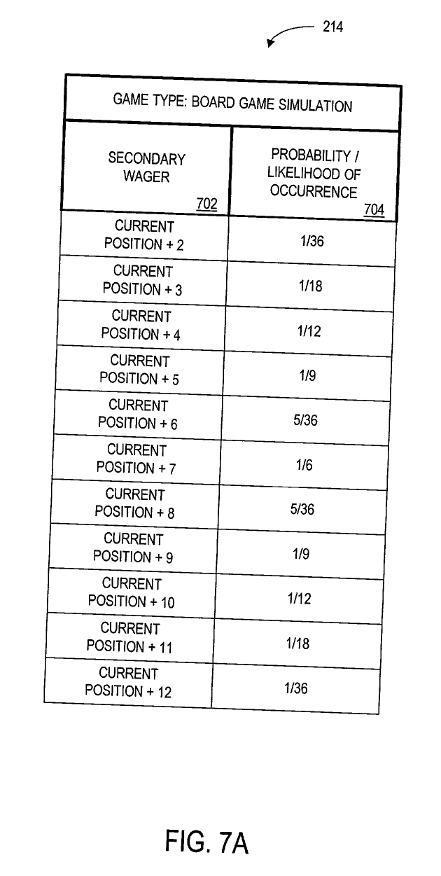

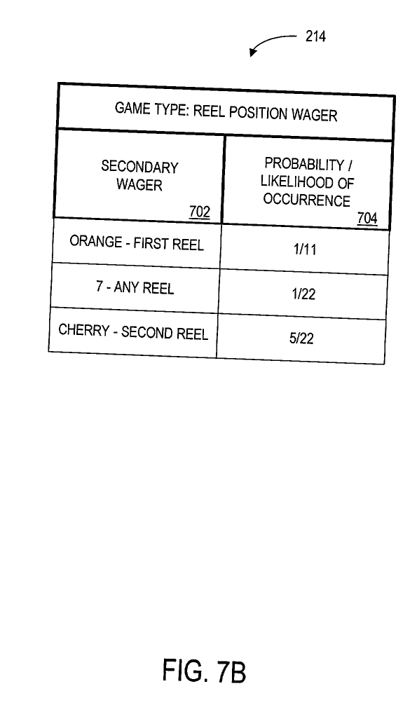

Turning to FIG. 7A, a tabular representation of an embodiment of a secondary game probability database 214 according to some embodiments of the present invention is illustrated. This particular tabular representation of a secondary game probability database 214 includes sample records or entries which each include information regarding probabilities, frequencies, or statistical likelihoods associated with a board game simulation-type secondary game. In some embodiments of the invention, a secondary game probability database 214 is used to track such things as secondary wagers and probabilities corresponding to the secondary wagers. Those skilled in the art will understand that secondary game probability database 214 may include any number of records or entries.

The particular tabular representation of a secondary game probability database 214 depicted in FIG. 7 for a particular secondary game defines a number of fields for each of the entries or records. The fields may include: (i) a secondary wager field 702 that stores a representation of a description of a secondary wager associated with the secondary game and (ii) a secondary game probability field 704 that stores a representation of a probability for a corresponding secondary wager.

The example secondary game probability database 214 of FIG. 7A provides example data to illustrate the meaning of the information stored in this database embodiment in the context of a board game simulation type of secondary game, in which a player may wager on the occurrence of criteria qualifying the player for a payout based on the movement of a representation of a board game piece. A secondary wager field 702 (e.g. “CURRENT POSITION+2”, “CURRENT POSITION+5”) may be used to identify and index the different secondary wagers available for the secondary game. The secondary game probability field 704 may be used by the controller 102 and/or the gaming device 106, for example, to determine probabilities (e.g., “1 in 36”) for the success of various secondary wagers.

An alternative example secondary game probability database 214 of FIG. 7B includes sample records or entries which each include information regarding probabilities, frequencies, or statistical likelihoods associated with a reel position wager-type secondary game. The alternative example secondary game probability database 214 of FIG. 7B provides example data to illustrate the meaning of the information stored in this database embodiment in the context of a reel position wager-type of secondary game. The secondary wager field 702 (e.g. “‘7’—FIRST REEL”) may be used to identify and index the different secondary wagers available for the reel position wager-type secondary game. The secondary game probability field 704 may be used by the controller 102, for example, to determine a probability (e.g., “1/22”) for the success of various secondary wagers.

5. Secondary Game Summary Database

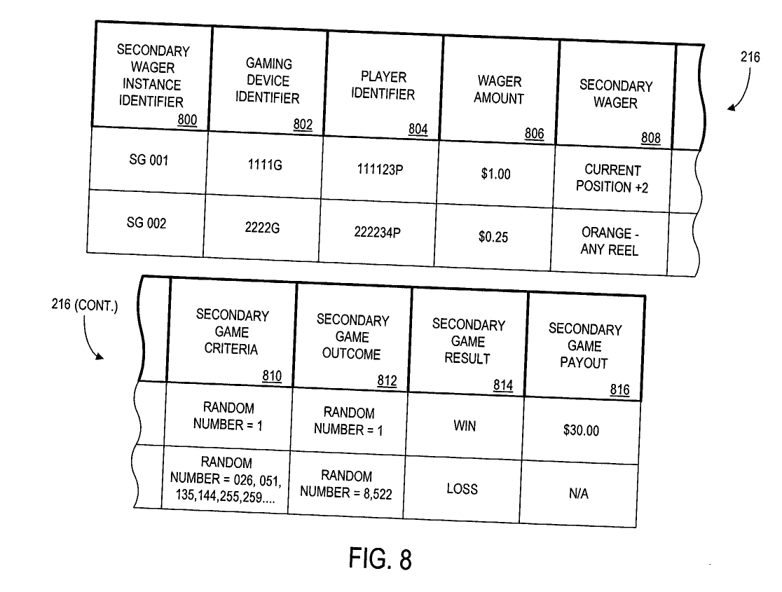

Turning to FIG. 8, a tabular representation of an embodiment of secondary game summary database 216 according to some embodiments of the present invention is illustrated. This particular tabular representation of a secondary game summary database 216 includes two sample records or entries which each include information regarding a particular secondary wager. In some embodiments of the invention, a secondary game summary database 208 is used to track player information such as secondary wagers, gaming device identifiers, wager amounts, secondary games, secondary game criteria, secondary game outcome information, a result of the secondary game, and secondary game payouts. Those skilled in the art will understand that a secondary game summary database 216 may include any number of records or entries.

The particular tabular representation of a secondary game summary database 216 depicted in FIG. 8 defines a number of fields for each of the entries or records. The fields may include: (i) a secondary wager instance identifier field 800 that stores a representation identifying a particular instance of a secondary wager; (ii) a gaming device identifier field 802 that stores a representation identifying one or more gaming devices at which the secondary game is played; (iii) a player identifier field 804 that stores a representation identifying a particular player; (iii) an amount field 806 that stores a representation of an amount wagered on the secondary game; (iv) a secondary wager field 808 that stores a representation of a description of the secondary wager; (v) a secondary game criteria field 810 that stores a representation identifying one or more criteria for determining if the secondary wager is successful; (vi) a secondary game outcome field 812 that stores a representation identifying outcome data associated with the secondary game; (vi) a secondary game result field 814 that stores a representation identifying a result of the secondary game; and a (vii) a secondary game payout field 816 that stores a representation of any payout provided the player based on the result of the secondary game.

The example secondary game summary database 216 of FIG. 8 provides example data to illustrate the meaning of the information stored in this database embodiment. A secondary wager instance identifier 800 (e.g., SG001, SG002) may be used to identify and index the different secondary wagers listed in the secondary game summary database 216. The secondary wager instance identifier 800 may be unique and alphanumeric, for example, but need not be either unique or alphanumeric. The gaming device identifier field 802 may provide information that allows the controller 102, for example, to identify at which device the secondary game was executed, and to instruct the appropriate gaming device to dispense a payout to a player. The player placing the secondary wager may be identified by the player identifier field 804. The amount field 806 may provide information that allows the controller 102, for example, to determine how much the player wagered on the secondary game. Such information may also allow the controller 102 to determine a payout amount if a secondary wager is successful. The secondary wager field 808 identifies the context of the secondary game, and the secondary game criteria field 810, secondary game outcome field 812, and secondary game result field 814 may provide information that allows the controller 102, for example, to determine whether the wager is successful. For example, the outcome data may be compared to the secondary game criteria to determine whether the player has correctly predicted an outcome of a secondary game in order to establish a result of the secondary game.

The secondary game criteria field 810 may store information defining certain criteria or conditions that must be met in order for a secondary wager to be deemed successful. Such information may include, for example, information indicating that the generation of a certain random number is required, that a specific slot machine outcome is required, that a slot machine reel must come to rest at a certain position or bearing a certain symbol, that a wager is at least a minimum amount, that a representation of a board game piece held an initial position or has achieved a certain position within a board game simulation, etc. Of course, different criteria may be appropriate for different types of secondary wagers.

The secondary game result field 814 may store information defining whether or not the player has placed a successful secondary wager (e.g., “WIN”, “LOSS”, “TIE” (or “PUSH”, “DRAW”)). The secondary game payout field 810 may be used by the controller 102, for example, to store an indication of any payout provided to the player identified in player identifier field 80×.

The first sample entry describes a secondary wager instance “SG001” at gaming device “1111G” by the player identified as “111123P” for an amount of “$1.00.”The secondary wager of “CURRENT POSITION+2” corresponds to the criteria that the generated random number be “1”. The secondary game outcome indicates a generated random number of “1”. A corresponding “WIN” is indicated as a result of the player's prediction, and a payout of “$30” was provided for the successful wager on the secondary game.

The second sample entry describes a secondary wager “SG002” at gaming device “2222G” by the player identified as “222234P” for an amount of “$0.25.” The secondary wager of “ORANGE-ANY REEL” corresponds to the game criteria that a generated random number be one of “026, 051, 135, 144, 255, 259 ..”. The secondary game outcome was a random number of “8,522”. A “LOSS” is indicated as a result of the player's prediction, and a payout of “N/A” indicates that no payout was provided for the unsuccessful secondary wager.

6. Primary Game Payout Database

In a typical primary game, as is well known in the art, one or more potential outcomes are predefined as winning outcomes (e.g., “CHERRY/CHERRY/CHERRY”, four of a kind) and correspond to a payout, and one or more potential outcomes are predefined as non-winning outcomes and typically do not result in a payout. A player at a gaming device (e.g., three-reel slot machine) typically makes a wager (e.g., one or more credits or coins) that the outcome of a play of the primary game (e.g., slot reel spin) will produce at least one of the predefined winning outcomes.

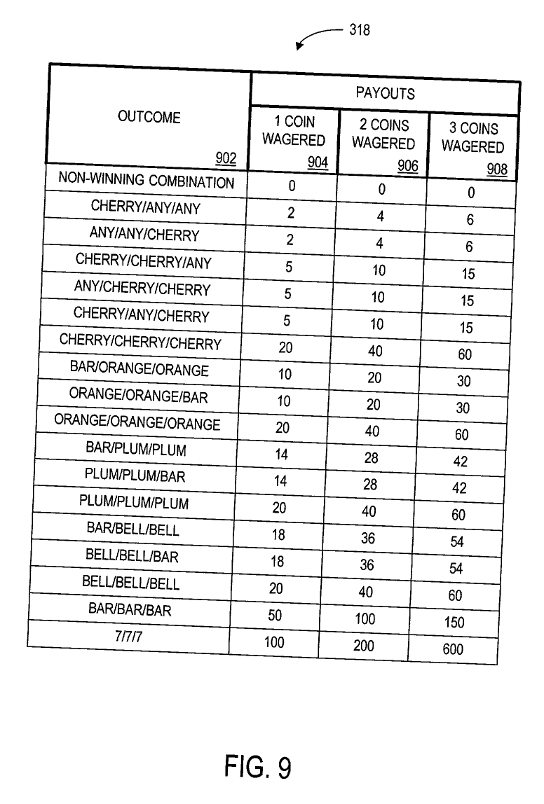

Turning to FIG. 9, a tabular representation of an embodiment of a primary game payout database 318 according to some embodiments of the present invention is illustrated. This particular tabular representation of a primary game payout database 318 includes sample records or entries which each include information regarding a particular primary game outcome. In some embodiments of the invention, a primary game payout database 318 is used to track such things as primary game outcomes and payouts corresponding to the various outcomes. Those skilled in the art will understand that a primary game payout database 318 may include any number of records or entries.

The particular tabular representation of a primary game payout database 318 depicted in FIG. 9 defines a number of fields for each of the entries or records. The fields may include: (i) a primary game outcome field 902 that stores a representation of an outcome of the primary game and (ii) primary game payout fields 904, 906, 908 that store a representation of one or more payouts for a corresponding primary outcome. In some embodiments, the amount of a payout is based on an amount wagered on the primary game.

The example primary game payout database 318 depicted in FIG. 9 provides example data to illustrate the meaning of the information stored in this database embodiment. Examples of outcomes of a three-reel slot machine game are provided in the primary game outcome field 902 (e.g., “CHERRY/CHERRY/ANY”). The primary game payout fields 904, 906, 908 list examples of payout amounts corresponding to the particular outcome based on different wagers (e.g., “1 COIN WAGERED”, “2 COINS WAGERED”, “3 COINS WAGERED”).

One sample entry describes a primary game outcome for a three-reel slot machine game of “CHERRY/CHERRY/ANY”. If the player wagered one coin, the corresponding payout is “5” coins. If the player wagered two coins, the payout is “10” coins. If the player wagered three coins, the payout is “15” coins.

7. Primary Game Probability Database

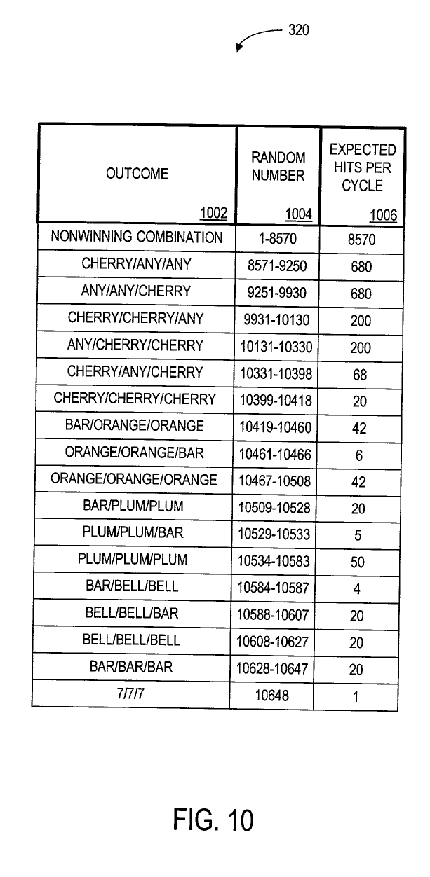

Turning to FIG. 10, a tabular representation of an embodiment of a primary game probability database 320 according to some embodiments of the present invention is illustrated. This particular tabular representation of a primary game probability database 320 includes sample records or entries which each include information regarding a particular primary game. In some embodiments of the invention, a primary game probability database 320 is used to track such things as primary game outcomes, random numbers, and expected hits per cycle corresponding to the potential outcomes of the primary games. Those skilled in the art will understand that primary game probability database 320 may include any number of records or entries.

The particular tabular representation of a primary game probability database 320 depicted in FIG. 10 defines a number of fields for each of the entries or records. The fields may include: (i) a primary game outcome field 1002 that stores a representation of an outcome of a primary game; (ii) a random number field 1004 that stores a representation of a number associated with the outcome; and (iii) an expected hits per cycle field 1006 that stores a representation of an expected number of times the particular outcome will occur within a “cycle” of plays of the primary game.

The example primary game probability database 320 depicted in FIG. 10 provides example data to illustrate the meaning of the information stored in this database embodiment. Examples of outcomes of a three-reel slot machine game are provided in the primary game outcome field 1002 (e.g., “NON-WINNING COMBINATION”, “CHERRY/CHERRY/ANY”). Each outcome corresponds to one or more numbers, or ranges of numbers, generated during play of the primary game, as indicated in the random number field 1004.

For example, a typical slot machine reel may include twenty-two positions at which the reel may come to rest during the course of a slot machine game. A typical machine may have three reels. Therefore, each machine may offer 10,648 unique combinations of reel positions (22×22×22=10,648). Thus, the information stored in the example random number field 50× may encompass the ordinal range of numbers including 1 through 10,648. Each number may be associated with a corresponding positioning of the slot machine reels. The expected hits per cycle field 50× lists examples of probability ratios in the form of expected hits per cycle (e.g., “8570” hits per every 10,648 plays). Such information may be used to determine a probability of achieving a particular outcome.

One sample entry describes a primary game outcome of “CHERRY/CHERRY/ANY”. The outcome corresponds to a random number in the range “9931-10130.” The likelihood of achieving such an outcome (e.g., of generating a random number in the range 9931-10130; of getting “CHERRY/CHERRY/ANY”) is represented as an expected hits per cycle of “200”, which corresponds to a probability of achieving the outcome 200 times in every cycle (i.e., in every 10,648 plays).

E. Process Descriptions

The system discussed above, including the hardware components and the databases, are useful to perform the methods of the invention. However, it should be understood that not all of the above described components and databases are necessary to perform any of the present invention's methods. In fact, in some embodiments, none of the above described system is required to practice the invention's methods. The system described above is an example of a system that would be useful in practicing the invention's methods.

For example, the secondary game summary database 216 described above is useful for tracking secondary wagers and information about them, but it is not absolutely necessary to have such a database in order to perform the methods of the invention. In other words, the methods described below may be practiced, for example, using a list of secondary wagers with corresponding odds, payouts, and/or other information.

Referring to FIG. 11, a flow chart is depicted that represents some embodiments of the present invention that may be performed by the controller 102 (FIG. 2), the gaming devices 106, 108, 110 (FIG. 3), and any combination thereof. As discussed above, the controller 102 may be one and the same with any or all of the gaming device 106,108,110.

It must be understood that the particular arrangement of elements in the flow chart of FIG. 11, as well as the order of example steps of various methods discussed herein, is not meant to imply a fixed order, sequence, and/or timing to the steps. Embodiments of the present invention can be practiced in any order, sequence, and/or timing that is practicable.

In general terms and referring to FIG. 11, a method of the present invention as performed by the gaming device 106 may be summarized as follows. In Step S1, the gaming device 106 receives a wager for a secondary game. In Step S2, the gaming device 106 determines at least one parameter for a potential secondary game outcome based on the wager. In Step S3, an outcome of the secondary game is determined. In Step S4, the gaming device 106 determines whether the secondary wager is successful. In Step S5, a payout is provided for on the secondary wager if the wager is successful.

In the subsections that follow, each of these five steps will now be discussed in greater detail.

Note that not all of these five steps are required to perform the method of the present invention, and that additional steps and alternative steps are also discussed below. Also note that the above general steps represent features of only some of the embodiments of the present invention. The general steps may be combined in any number of different ways so that the method includes fewer actual steps. One or more general steps may also be subdivided in any number of different ways into more actual steps.

For example, in some embodiments many additional steps may be added to update and maintain the databases described above. As indicated, however, it is not necessary to use the above-described databases in all embodiments of the invention. In other words, the methods of the present invention may contain any number of steps that are practicable to implement the processes described herein. The methods of the present invention are now discussed in detail.

1. Receive a Wager on a Secondary Game

In Step S1, the gaming device 106 receives a wager on a secondary game. In some embodiments, the gaming device 106 receives an indication of a secondary wager, for example, through the player's transacting or interacting with the gaming device 106. The gaming device 106 may sense that coins are deposited, for example, in a currency acceptor designated for secondary wagers. In another example, the player is prompted by the gaming device 106 to input money for a secondary wager.

In some embodiments, after being prompted, or of his own volition, a player may communicate information about a secondary wager to the gaming device 106. Communication may occur through keys, pointer device, touch screens, voice input, wireless technology, buttons, other mode, or any combination of such modes.

In some embodiments, a player presses a button on the gaming device 106 to place a secondary wager. For example, a “Side Bet” button may debit an account balance and direct the debited amount to a secondary wager. One or more secondary wager criteria may be associated with pressing a particular button, and different buttons may be provided for different secondary wagers.

In another example, a secondary wager may be indicated to the gaming device 106 by receiving a card. The card may be one corresponding to a financial account, such as a credit card or debit card. The card may also be an ATM card or a player tracking card. Information about a secondary wager, such as one more preferences for a secondary wager amount and/or secondary wager criteria, may be stored in a memory of a card and received via the card reader 310.

In some embodiments of the present invention, the gaming device 106 presents an offer to the player and the player indicates his acceptance or rejection of an offered secondary wager. Such an offer may indicate an invitation to input secondary wager information, one or more criteria, a probability of success, a potential outcome, a minimum or maximum wager amount, or any combination of such information. The offer may be presented to the player in many different ways including: via text displayed on an LCD or other display screen or device; via one or more buttons for placing a secondary wager; via back-lighting pre-composed text; via a message sent to a player device, such as a PDA, via text printed on a paper, via a computer synthesized voice; via a pre-recorded voice; via a live voice; and/or via a Braille representation.

If the player rejects the offer, the process terminates. In some embodiments, the system may present an alternate offer or modify the existing offer (e.g., suggest different criteria, a different probability, or a different payout) to make it more appealing. If the player accepts the offer, the gaming device 106 proceeds to determine an outcome of the secondary game.

According to various different embodiments, a player may indicate his acceptance of a secondary wager in many different ways including: pressing an “accept” or similar button on a gaming device 106 or a touch screen of the device; verbally communicating his acceptance; signing a written document and, optionally, inserting the executed document into the gaming device 106; signing a touch screen; providing a finger print; providing a retinal scan or other unique biometric, providing a print or a number of a credit or debit card; or transmitting a written, electronic, or voice message to a phone number or address designated by the gaming device 106.

2. Determine at Least One Parameter for a Secondary Game Outcome

In Step S2, the gaming device 106 determines at least one parameter associated with a potential outcome of the secondary game, based on the secondary wager. For example, the secondary wager may indicate the player's prediction about a potential outcome, or some aspect of a potential outcome, of the secondary game.

In some embodiments, the secondary wager criteria may be determined based on the wager amount. Different secondary wager amounts could be associated with different predictions for the outcome of the secondary game. For example, a $1 side bet may uniquely indicate a secondary wager that an “ORANGE” symbol will appear on any reel in a reel slot machine game. The casino may establish such associations based on the probabilities of various secondary wagers.

In other embodiments, the player inputs a selection to the gaming device 106 in placing the wager. For example, in a secondary game based on reel slot machine game, the gaming device 106 may prompt the player to select one of the various reel symbols and to pick one or more reels. In another example, the gaming device 106 prompts the player to select one of the various reel symbols (e.g., “7”) and to pick one or more displayed reel stops in a multi-lined slot machine game. In some embodiments, the player touches a display screen to make his selections.

In some embodiments, a player or casino representative, such as a slot host, may indicate a secondary wager to the gaming device 106 by speaking into or near a microphone at the gaming device 106. Voice recognition may be used to translate the audio signal into information about a secondary wager for use by the gaming device 106. In other embodiments, a player's PDA, cell phone, or other device may indicate a secondary wager to the gaming device 106 using, for example, a wireless protocol (such as Bluetooth as described at http://www.bluetooth.com/developer/specification/specification.asp).

In some embodiments, the player may be identified to the gaming device 106 and one or more parameters of the secondary wager may be identified based on stored information about the player. For example, one or more secondary wagers may be associated with the player. For instance, the player may have registered his favorite side bets with the system 100. Alternatively, or in addition, the system 100 may maintain a gaming history for the player, such as in secondary game summary database 216, which may be used to determine the side bets the player has made the most often, the side bets the player has won the most on, the side bets the player has made most recently, etc.

Other stored information about the player may include, for example, a preference for a particular secondary wager amount, a preference for a particular secondary game on which to place a wager, and/or one or more criteria for predicting an outcome of a secondary game. Information about the player may reveal which secondary wagers may be particularly desirable to the player. For example, a player at a gaming device 106 who has indicated a preference for racing may be likely to place a secondary wager on a race game. The gaming device 106 may retrieve information about secondary wagers from its own databases, databases at the controller 102, and/or other online databases. Such information may be received by the gaming device 106, for example, from the controller 102 in response to transmitting the player identifier 400 to the controller 102.

Thus, the receipt of information regarding a player, the player's preferences, gaming history, and other information may allow the system 100 of the invention to provide secondary wagers tailored to a particular player and to determine secondary wagers that the player may be predisposed to accept.

3. Determine an Outcome for the Secondary Game

In Step S3, an outcome of the secondary game is determined. As described above, the outcome of a primary game, such as a slot machine game or video poker game, may provide the basis on which the outcome of the secondary game is determined. For example, data indicating one or more reel symbols resulting from reel spin may comprise the secondary game outcome. In other embodiments, the outcome of the secondary game is independent of a primary game. For example, the secondary game outcome may be associated with a simulated dice roll (e.g., “7”), a move in a representation of a board game, a player selection in a bonus game, any result of a player selection in a bonus game (e.g., a bonus prize of 100 coins), or any combination thereof.

In some embodiments, the gaming device 106 may generate a random number and determine an outcome of the secondary game based on the random number. For example, gaming device 106 may determine a final game board position based on a random number generated for the board game simulation. In other embodiments, the outcome of the secondary game, such as the number of spaces a piece moves, or the final position of a piece, may be determined based on a number generated for the primary slot machine game, such as for a reel spin.

4. Determine Whether the Secondary Wager is Successful

In Step S4, the gaming device 106 determines whether the secondary wager is successful for the player. In order to determine whether the secondary wager was successful for the player, the gaming device 106 compares the one or more criteria of the secondary wager with the outcome of the secondary game.

For example, if the player predicted that a “CHERRY” symbol would appear on the second reel after a slot spin, the gaming device 106 compares those criteria to the actual outcome of the slot spin to determine whether the player successfully predicted some aspect of the actual slot spin outcome.

In another example, the one or more parameters indicated by the secondary wager may indicate a potential outcome or set of potential outcomes that corresponds to one or more random numbers. If a random number (or random numbers) associated with the outcome of the secondary game satisfies the one or more parameters of the secondary wager (e.g., is one of the random numbers associated with the predicted outcome), the secondary wager is successful.

In another example, the player could have wagered that a simulated dice roll in a board game simulation would result in a game token moving to a particular position. If the secondary game outcome is such that the game token in fact moves to the predicted position, the secondary wager is successful. In another example, the player could have wagered that a simulated dice roll in a board game simulation would result in a roll of “7”. If the roll is “7”, the player successfully predicted the secondary game outcome.

If the secondary wager was unsuccessful (e.g., the secondary game outcome failed to meet one or more of the parameters of the secondary wager), the process ends.

5. Provide a Payout Based on the Secondary Wager

In Step S5, a payout is provided based on the secondary wager. The gaming device 106 provides the payout, be it cash, tokens, reward points, tickets, stamps, consumables, product, information, equity, options, gambling tokens, toys, other products, and services. Products may be in the form of information such as music, audio, and video recordings. Entertainment products, such as music videos may be displayed directly on the dispensing device 106, or transferred in binary form, to a player's PDA. Payouts may include game feature add-ons, such as bonus rounds or eligibility for progressive jackpots. Services may include: clothes washing, car washing, etc. Identifying a payout may entail deciding whether to offer a payout at all.

For a gaming device-type dispensing device in particular, payouts may include: cash; credits; gambling tokens; reward points; increased odds of winning; increased prize tables; insurance against losses; the ability to play a large denomination machine for a small denomination; the free use of an extra slot in a multi-slot machine; being permitted to play for free; having winnings rounded to a higher level (e.g., $50 rounded to $75); the enablement of extra prize-winning symbols on a slot machine; the enablement of extra pay lines on the slot machine; discounts on various products; and auxiliary payouts, such as free (or subsidized) meals or hotel rooms.

As noted above, if the outcome of the secondary wager is not a winning outcome (i.e., fails to meet the criteria of the secondary wager), then the process ends and the gaming device typically does not need to provide a payout to the player. In some embodiments, however, gaming device 106 may provide a benefit to the player in order, for example, to encourage the player to continuing playing a primary game, a secondary game, or both.

5.1. Determine the Payout

In some embodiments, the payout is based on the wager amount. For example, the gaming device 106 can calculate the payout amount based on a multiplier of the wager amount (e.g., “30:1”, “5×”). In another example, the gaming device 106 looks up the payout corresponding to the secondary wager (e.g., “30” coins) in a database, such as secondary game payout database 212.

In some embodiments, the payout is based on the statistical likelihood that the secondary wager will be successful. In a board game example, the slot machine of the present invention may reward less favorable payouts for wagers indicating that the board game piece will move a total of seven spaces due to the fact that of the thirty-six unique outcomes achievable with a pair of six-sided dice, a large proportion of those outcomes result in a total of “7”.

In some embodiments, the payout is based on a predetermined flat rate. For example, all successful secondary wagers for a particular secondary game may receive a $1 payout regardless of the specified criteria. In another example, all successful secondary wagers for a particular secondary game may receive a payout that is five times the wager amount, regardless of the specified criteria.

5.2. Provide the Payout

In some embodiments, the payout is dispensed to the player by the gaming device 106 as coins or tokens, preferably via a payout dispenser 328, such as those possessed by slot machines for dispensing tokens. In other embodiments, the payout is provided to the player as free spins or as an amount credited to an account balance of the player. In yet other embodiments, the gaming device 106 rewards the player by turning on one or more “pay-to-play” features of a primary game, such as by making the player eligible for one or more bonus games. In still other embodiments, the gaming device 106 provides a receipt or tickets redeemable for cash, credit, products, or services.

In some embodiments, the gaming device 106 provides the payout in response to a signal to do so from the controller 102. Information may be dispensed on a machine-readable medium, such as a floppy disk or a DVD. Information or some other indication of a payout, such as a credit balance, may also be transmitted to a player device, such as a cell phone or a PDA, or stored on a card belonging to the player.

F. Example Illustrative Embodiment of the Invention

The following example illustrates one sample embodiment of the present invention. It involves a secondary wager predicting an outcome of a reel slot machine game.

A player approached a three-reel, three-lined slot machine, inserted her player tracking card into the card reader, and inserted the maximum bet for one payline across the second displayed line. On the display screen, she was presented with the following message: Would you like to place a $1 side bet on your spin? Even if your spin does not hit, you could still win your side bet! Select from the following options:

1. Pick your favorite reel symbol (or let me pick one for you) and guess which reel your symbol will appear on! And it doesn't have to be on the payline! You can select an additional symbol for $1 more, or pick an additional reel for $1 more—it's up to you! Win up to $5 on your side bet!

2. Pick a “Hot Spot”! Pick your favorite reel symbol (or let me pick one for you) and guess which displayed stop your symbol will appear at! You can pick any one of the nine displayed stops, even one that's not on your payline! Win up to $30 on your side bet!

Just insert $1 or hit the “Side Bet” button, then pick one of the reel symbols displayed at the bottom of the screen (or select “Random Symbol”) to get started.

Once the player had placed a inserted her player tracking card into a slot machine-type gaming device 106 and placed a wager on the slot machine game, the gaming device 106 presented the above offer for a secondary wager.

The player signaled her acceptance of the offer by inserting another dollar into the slot machine and selected a displayed “ORANGE” reel symbol on the slot machine's touch screen by pressing it. The slot machine then prompted the player to select a reel or a displayed position. The player pressed a displayed “2” above the second displayed reel and then pressed a “Finish” button on the slot machine's touch screen to complete the side bet. The gaming device 106 stored an indication of the one dollar secondary wager, the “ORANGE” reel symbol criterion, and the second reel criterion, and prompted the player to spin the slot reels. She pushed the “Spin” button to play the slot machine game.

The resulting slot spin showed “CHERRY/ORANGE/PLUM” on the first line, “PLUM/BELL/ORANGE” on the second line (the player's payline), and “BELL/BAR/PLUM” on the third line. The result was not a winning outcome in the primary slot machine game, based on the slot game's payout table and the player's payline. However, the second reel displayed one “ORANGE” symbol on the first line (not on her payline). The gaming device 106 compared the outcome of the spin with the outcome predicted in the player's side bet and determined that the player had won her side bet because she had predicted the occurrence of an “ORANGE” reel symbol on the second reel, regardless of whether it was on the payline or not. The gaming device 106 dispensed $5 in coins to the player for the successful side bet.

G. Additional Embodiments of the Invention

The following are example alternative variations which illustrate additional embodiments of the present invention. It should be understood that the particular variations described in this section can be combined with the different embodiments, or portions thereof, described above in any manner that is practicable. These examples do not constitute a definition or itemization of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

The player may, in addition, communicate other personal information, such as a name, demographic description, address, gaming history, hobbies, profession, etc. Any such information may then be stored in a database such as, for example, the player database 208 depicted in FIG. 4.

In some embodiments, information about the player may be useful in determining a secondary wager to offer to the player. For example, information about what types of secondary wagers the player has placed before, what secondary wagers the player has been offered before, what offers the player has refused, what type of odds the player prefers, or a combination of such information, may be helpful in identifying a secondary wager that the player is likely to accept.

In obtaining information about a player, the gaming device 106 may engage the player in a survey. The survey may be interactive, determining new questions based on answers to prior ones. The survey may be designed to elicit characteristics of a player that help determine what type of secondary wagers the player is likely to make or accept.

Information about the player may disclose one or more types of activities or types of games of interest the player. For example, information about the player may indicate the player's preference for certain hobbies or interests; for particular sports (e.g., basketball) or types of sports (e.g., racing sports, team sports); for particular games (e.g., MONOPOLY™, poker) or types of games (e.g., board games); for wagers having certain odds; or for any combination of the above.

In some of the various embodiments in which a wager amount is determined (e.g., by entering coins, by pushing a button, by entering a card, by debiting an account), one portion of a received wager amount may be directed to a primary wager, and another portion of the wager amount may be directed to a secondary wager. In some embodiments, the received total wager amount may be apportioned to the primary and secondary wagers based on player preferences, on predetermined percentages or amounts, or in response to a player selection.

A player may record personal information and information about a secondary wager on a user device such as a PDA. This information may be accessed by the gaming device 106 in communication with the user device. For example, if the player grants a gaming device 106 permission to access his PDA's data, the player's PDA may communicate secondary wager data, via infrared transmissions, for example, to the gaming device 106. In view of the personal information and/or wager data, the gaming device 106 may present an offer for a secondary wager to the player.

In some embodiments, the gaming device 106 at which the player is playing may not have a particular secondary game in memory (e.g., in data storage device 304). The controller 102 may use information in the gaming devices database 210 to identify another gaming device (e.g., gaming device 108) having the particular secondary game. As discussed above, the controller 102 may enable communication between the two gaming devices, so that the player may play the secondary game from his gaming device 106. In some embodiments, software for operating the secondary game may be transmitted to the player's gaming device 106 via the controller 102. In other embodiments, software for operating the secondary game may be transmitted to the controller 102, and the player may play the secondary game via his gaming device 106 in communication with the controller 102.

It is further a feature of the present invention that any of the gaming devices 106, 108, 110 may operate to determine odds for various outcomes of the secondary game of chance.

In some embodiments, the probability or probabilities associated with a secondary game may be determined based on the type of secondary game. For example, one or more probabilities may be retrieved from a database (e.g., secondary game probability database 214) based on the secondary game type, such as a dice roll simulation or reel symbol prediction game.

In some embodiments, once a secondary wager is received, gaming device 106 looks up a corresponding probability for the side bet in the secondary game probability database 214. For example, if the player makes a secondary wager predicting that a “CHERRY” reel symbol will show anywhere on the first reel of a slot machine, the slot machine can look up a corresponding probability (e.g., “30:1”) that the player will accurately predict the outcome. In some embodiments, the gaming device 106 could also determine a payout amount based on the probability. For example, a particular payout (e.g., “30:1”) could be associated with a predetermined probability (e.g., “36:1”).

Alternatively, or in addition, a gaming device 106 may calculate a corresponding probability based on information about the secondary game and/or the secondary wager criteria. For example, the gaming device 106 may not have a stored probability corresponding to the particular secondary wager, but may be able to calculate a probability based on data about the secondary game and secondary wager criteria, such as the available reel symbols, the number of available reel symbols, the number of predicted symbols, the positions of the symbols on the reel, or the number of positions and/or symbols displayed when the reels come to rest, as well as various combinations of these and other factors. Of course, different factors will be appropriate for different types of games.

For example, many typical board games dictate player movements via a pair of six-sided dice. Thus the statistical likelihood of certain amounts of movement may be calculated based on the probabilities associated with each roll of the dice. Consider the following table and corresponding likelihood of occurrence, wherein the leftmost column indicates the result of a roll of two six-sided dice, the center column indicates the various individual dice combinations required to achieve the corresponding result and the rightmost column indicates the likelihood of occurrence of the corresponding result.

| Result | Required Value Combination(s) | Likelihood |
|---|---|---|
| 1 | None | 0 |
| 2 | (1,1) | 1 in 36 |
| 3 | (1,2), (2,1) | 1 in 18 |
| 4 | (1,3), (3,1), (2,2) | 1 in 12 |
| 5 | (1,4), (4,1), (2,3), (3,2) | 1 in 9 |
| 6 | (1,5), (5,1), (2,4), (4,2), (3,3) | 5 in 36 |
| 7 | (1,6), (6,1), (2,5), (5,2), (3,4), (4,3) | 1 in 6 |
| 8 | (2,6), (6,2), (3,5), (5,3), (4,4) | 5 in 36 |
| 9 | (3,6), (6,3), (4,5), (5,4) | 1 in 9 |
| 10 | (4,6), (6,4), (5,5) | 1 in 12 |
| 11 | (5,6), (6,5) | 1 in 18 |
| 12 | (6,6) | 1 in 36 |

Based on these probabilities, the corresponding payouts for secondary wagers corresponding to the various “roll” results could be arranged such that a player predicting the occurrence of a representation of a board game piece advancing only two spaces may receive a relatively larger payout than those predicting a move of seven spaces (since seven is the most likely result and two is among the least likely results). Of course, the payouts associated with the various secondary wagers need not be based on the corresponding probabilities.

In another example, consider the following illustrations of three basic twenty-two stop slot machine reels and their corresponding symbol allocations.

| Stop | Reel 1 | Reel 2 | Reel 3 |
|---|---|---|---|
| 1 | Cherry | Orange | Plum |
| 2 | Plum | Bell | Bell |
| 3 | Bell | Bar | Orange |
| 4 | Bar | Cherry | Plum |
| 5 | Bell | Bar | Orange |
| 6 | Orange | Cherry | Cherry |
| 7 | Bell | Bar | Plum |
| 8 | Plum | Bar | Orange |
| 9 | Bell | Orange | Plum |
| 10 | Bell | Bar | Orange |
| 11 | Cherry | Cherry | Plum |
| 12 | Plum | Bar | Plum |
| 13 | Bell | Plum | Orange |
| 14 | Bar | Bar | Cherry |
| 15 | Bell | Orange | Plum |
| 16 | Orange | Cherry | Plum |
| 17 | Bell | Bar | Orange |
| 18 | Plum | Bar | Plum |
| 19 | Bell | Bell | Bar |
| 20 | Bell | Bar | Plum |
| 21 | Plum | Cherry | Orange |
| 22 | 7 | 7 | 7 |

Based on this example information, a gaming device 106 could calculate the probability of a player successfully placing a wager and predicting the occurrence of a “7” symbol appearing on the first reel of a primary slot machine game as 1 in 22.

In some embodiments, a player device, such as a PDA, may indicate secondary wagers on behalf of its owner or another person. The device may be preprogrammed to enter into secondary wagers based on predefined parameters. For example, a player may program his combination cell phone/PDA to place a secondary wager that a dice roll simulation will result in a “5”. Of course, one or more primary wagers may be programmed in this manner as well. Then, for example, when the player walks by a slot machine-type gaming device 106, the slot machine may broadcast, via infrared frequencies, a secondary wager offer. The cell phone/PDA may then accept the offer on the player's behalf by transmitting the player's identifying information. The cell phone/PDA may subsequently alert the player that he has entered into a secondary wager.

The secondary game probability field 404 may also provide information that allows the controller 102, for example, to identify one or more secondary wagers having probabilities of interest to a player.

In some embodiments, the player need not place a primary wager at the gaming device. For example, a player could place only a secondary wager on a dice roll simulation at a gaming device. In some embodiments, a second player may be playing the primary game of a gaming device at which a first player places his secondary wager.

In some alternative embodiments, the gaming device 106 provides an offer for a secondary wager to the player and the player accepts the offer. Secondary wagers may be stored by the system 100 in a database such as, for example, the secondary game payout database 212. The gaming device 106 or the controller 102 may access relevant secondary wagers from the secondary game payout database 212 when a player interacts with a gaming device 106. The gaming device 106 or the controller 102 may use a rules-based system, for example, to determine an appropriate secondary wager. In some embodiments, the secondary wager may be selected or derived using artificial intelligence.

In some embodiments the gaming device 106, for example, determines one or more criteria for a secondary wager and determines a probability that the wager will be successful based on the criteria. The gaming device 106 then provides an indication of the probability of the secondary wager to the player, who then indicates an acceptance or rejection of the secondary wager. Alternatively, the gaming device 106 may determine whether the determined probability satisfies a preference associated with the player. For example, a player may have a stored preference in player database 208 for side bets having a probability higher than 100:1. If the gaming device 106 determines that the probability of the secondary wager being successful is greater than 100:1, the gaming device 106 may place the secondary wager for the player without requiring the player to otherwise indicate his acceptance of the wager.

In other alternative embodiments, the gaming device 106 determines a payout if the side bet is successful, and provides an indication of the potential payout to the player. The player may then indicate his acceptance or rejection of the secondary wager. Alternatively, similar to the example above, the gaming device 106 may execute the secondary wager based on a payout preference associated with the player without requiring the player to indicate his acceptance of the secondary wager.

Any information about a secondary wager may be stored in a database such as secondary game summary database 216. In some embodiments, an indication of the outcome of the secondary game may be transmitted to a player tracking card or to a printer. Game summary information could be printed on a receipt for the player. A receipt may provide a record for the player of his gaming experience, and may also be used by the player to receive any payouts for his gaming session. In some embodiments, the receipt includes a code, such as a bar code, which contains information about the player, the player's game summary information, account balances, and/or other information. The receipt may be inserted into another slot machine enabled to decode the information. The new slot machine can dispense any payouts to the player, and can also reference information from the receipt in determining whether to offer a secondary wager, what types of wagers to offer, player preferences, etc.

In some embodiments, players may receive ratings based on how often they place secondary wagers, on how often they reject offers for secondary wagers, or both. The ratings may be used in determining what secondary wagers to offer the player.

According to some alternative embodiments, a secondary game outcome may be based on more than one gaming device, including gaming devices other than the gaming device at which the player is playing. According to other alternative embodiments, a secondary game outcome may be based on a primary game associated with a different player.

According to some embodiments, a gaming device receives a wager from a player predicting an outcome of a secondary game, and determines a result of the wager based on the prediction. According to other embodiments, the gaming device receives a wager amount and a prediction about the outcome of a secondary game, and provides a payout based on the prediction.

Various embodiments of the present invention offer a player the opportunity to place a secondary wager at a gaming device. According to some embodiments of the present invention, a gaming device, such as a slot machine, executes a slot machine game in conjunction with one or more secondary games on which a player can wager.

In some embodiments, a secondary game comprises a player inputting a monetary value in excess of an amount normally required to play a reel slot game, and inputting information representing a symbol selection, or reel position selection, for one or more of the reels of the slot machine. The slot machine may then provide a payout if the selected symbol, for example, appears on one of the reels of the slot machine in the standard game.

For example, a player may input four coins into a slot machine, with three coins to be applied toward a wager in a slot machine game and a fourth quarter to be applied to a secondary game. According to this example, the player may input a parameter to the machine indicating the context of the secondary game. Such a parameter may indicate, for example, a side bet that a “CHERRY” symbol will appear on the payline of the slot machine at the completion of the slot machine game. The player may input such a parameter by, for example, actuating a button on the slot machine that indicates to the slot machine the reel at which the player believes the “CHERRY” will appear.

According to some embodiments of the invention, the result of the activity establishing the outcome of the side bet or secondary game is independent of the result of a primary game. For example, a slot machine may be outfitted with an electronic, mechanical or electromechanical representation of a racetrack, and may operate to move representations of cars or other race participants around the racetrack. In such sample embodiments, the outcome of the side bet may be determined either in conjunction with, or independently of, the outcome of a primary slot game. For example, the outcome of a secondary game may be based on a random number used to generate the result of a primary game. In another example, the outcome of a secondary game is determined via a separate, random or predetermined process.

According to other embodiments of the invention, a gaming device may display an electronic, mechanical or electromechanical representation of a board game. The gaming device may generate an outcome associated with the represented board game. For example, a player may place a wager as to where the player believes a representation of a board game piece will land on the representation of the board game.

Some embodiments of the present invention allow a player to place a wager on random outcomes that players typically cannot bet on, such as various aspects of bonus rounds. For example, some embodiments allow the player to bet on the size of a bonus prize, on how many spaces a game symbol moves on a represented game board, and/or on how many turns in the bonus round a player will get before the bonus round ends.

Some embodiments of the present invention provide for determination and/or calculation of odds and/or of payouts for a secondary game of chance.

According to other embodiments of the present invention, a system comprises a controller in communication with one or more gaming devices. In some embodiments, the controller or gaming device receives an indication of one or more secondary wagers and directs one or more gaming devices to execute one or more secondary games. In some embodiments, the controller provides an offer for a secondary wager to a player at a gaming device.

Some embodiments may also provide for dispensing a payout or crediting an account balance if the secondary wager is successful.

H. Conclusion

It is clear from the foregoing discussion that the disclosed systems and methods to offer secondary wagers represents an improvement in the art of gaming devices. While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, and enhancements are possible without departing from the teachings thereof. All such modifications are intended to be encompassed within the following claims.

What is claimed is:

1. A method comprising:
receiving a wager for a secondary game at a gaming device offering a primary game,
in which the wager indicates at least one parameter corresponding to a potential outcome of the secondary game;
determining an outcome of the secondary game; and
providing a payout for the secondary game.

2. The method of claim 1, in which receiving the wager comprises:
receiving a wager amount.

3. The method of claim 1, further comprising:
determining an outcome of the primary game.

4. The method of claim 3, in which providing the payout comprises:
providing the payout based on the outcome of the primary game.

5. The method of claim 3, in which determining the outcome of the secondary game comprises:
determining the outcome of the secondary game based on the outcome of the primary game.

5. The method of claim 1, in which providing the payout comprises:
providing the payout based on the at least one parameter and the outcome of the secondary game.

6. The method of claim 5, in which providing the payout further comprises:
providing the payout based on a wager amount.

7. The method of claim 1, in which determining the outcome of the secondary game comprises:
determining an outcome of a bonus game.

8. The method of claim 1, in which determining the outcome of the secondary game comprises:
determining an outcome that represents a roll of at least one die.

9. The method of claim 1, in which the secondary game is associated with a slot machine game.

10. The method of claim 1, in which receiving the wager comprises:
receiving the wager from a player.

11. The method of claim 1, in which receiving the wager comprises:
receiving the wager from a player tracking card.

12. The method of claim 1, in which receiving the wager comprises:
receiving the wager from a controller.

13. The method of claim 1, in which receiving the wager comprises:
receiving the wager from a personal digital assistant (PDA).

14. The method of claim 1, in which receiving the wager comprises:
receiving the wager from a second gaming device.

15. The method of claim 1, in which receiving the wager comprises:
receiving the wager via a touch screen.

16. The method of claim 1, in which the primary game is a reel slot machine game.

17. The method of claim 1, in which the primary game is a video poker game.

18. The method of claim 1, in which the primary game is a video keno game.

19. The method of claim 1, in which the primary game is a video blackjack game.

20. The method of claim 1, in which the primary game is a video bingo game.

21. The method of claim 1, in which providing the payout comprises:
dispensing the payout.

22. The method of claim 1, in which providing the payout comprises:
determining an amount of the payout.

23. The method of claim 22, in which the amount is predetermined.

24. The method of claim 22, in which determining the amount comprises:
determining the amount based on the at least one parameter.

25. The method of claim 22, in which determining the amount comprises:
determining a probability corresponding to the at least one parameter; and
determining the amount based on the probability.

26. The method of claim 22, in which determining the amount comprises:
determining the amount based on a wager amount.

27. The method of claim 1, in which the at least one parameter comprises an indication of a location at which a representation of a board game piece will come to rest.

28. The method of claim 1, further comprising:
determining a location at which a representation of a board game piece will come to rest; and
in which providing the payout comprises:
providing the payout based on the at least one parameter and the location.

29. The method of claim 28, in which determining the location comprises:
determining a random number; and
determining the location based on the random number.

30. The method of claim 1, further comprising:
determining a random number; and
determining an outcome of the primary game based on the random number.

31. The method of claim 30, in which determining the outcome of the secondary game comprises:
determining the outcome of the secondary game based on the random number.

32. The method of claim 30, further comprising:
determining a second random number; and
determining the outcome of the secondary game based on the second random number.

33. The method of claim 1, further comprising:
transmitting an offer for the wager to a player.

34. The method of claim 1, in which the at least one parameter includes an indication of at least one of:
a wager amount,
a reel,
a reel stop,
a position on a representation of a game board,
a board game piece,
a symbol,
a roll of at least one die,
a payout,
an event,
a time,
a period of time,
a probability,
a number of symbols,
a number of positions,
a number of plays,
a number of spins,
a number of cards,
a number of hands,
a number of players,
a number of slot machines,
a gaming device, and
a player.

35. The method of claim 1, in which the at least one parameter corresponds to a board game simulation wager.

36. The method of claim 1, in which the at least one parameter corresponds to a reel position wager.

37. The method of claim 1, in which the at least one parameter comprises an indication of a reel stop.

38. The method of claim 1, in which the at least one parameter comprises an indication of a reel.

39. The method of claim 1, in which the at least one parameter indicates a reel and a symbol.

40. The method of claim 1, in which the at least one parameter indicates a symbol and a reel stop.

41. The method of claim 1, in which the at least one parameter indicates a symbol and a payline.

42. A method comprising:
receiving a wager for a secondary game at a slot machine providing at least one slot machine game,
in which the wager identifies at least one parameter of a predicted outcome of the secondary game;
determining an outcome of the at least one primary game; and
determining an outcome of the secondary game based on the at least one parameter and the outcome of the at least one primary game.

43. A method comprising:
receiving an indication of a wager amount;
determining a first portion of the wager amount to be applied to a slot machine game;
determining a second portion of the wager amount to be applied to a secondary game;
receiving data from a player, the data indicating a first symbol of the slot machine game;
determining an outcome of the slot machine game, the outcome comprising a second symbol; and
providing a payout based on the outcome of the slot machine game and the data.

44. A method comprising:
receiving a wager amount from a player;
determining a first portion of the wager amount to be applied to a slot machine game;
determining a second portion of the wager amount to be applied to a secondary game, the secondary game being associated with a plurality of reel stops;
receiving data from the player, the data indicating at least one reel stop of the plurality of reel stops;
determining an outcome of the secondary game; and
providing a payout based on the outcome of the secondary game and the data.

45. A method comprising:
receiving a wager for a slot machine game from a player;
receiving an indication of a probability;
determining at least one secondary wager based on the probability;
transmitting an indication of the at least one secondary wager to the player; and
receiving an acceptance of the at least one secondary wager from the player.

46. The method of claim 45, further comprising:
determining an outcome of the at least one secondary wager; and
providing a payout to the player based on the outcome.

47. A method comprising:
receiving a secondary wager at a first gaming device;
determining an outcome of a primary game at a second gaming device; and
providing a payout based on the secondary wager and the outcome.

48. A method comprising:
receiving a secondary wager at a first slot machine, the secondary wager indicating a second slot machine;
determining an outcome of a game initiated at the second slot machine; and
providing a payout based on the secondary wager and the outcome of the game.

49. A method comprising:
receiving a first wager for a slot machine game having a plurality of reel symbols; and
receiving a second wager that identifies at least one reel symbol of the slot machine game.

50. A method comprising:
receiving a first wager amount, in which the first wager amount is associated with a slot machine game;
receiving a second wager amount, in which the second wager amount is associated with a secondary wager;
receiving a first parameter identifying a first reel;
receiving a second parameter identifying a first reel symbol;
determining an outcome of the slot machine game, in which the outcome comprises at least one reel symbol on a second reel, and in which the at least one reel symbol includes a second reel symbol;
determining whether the first reel symbol matches the second reel symbol;
determining whether the first reel matches the second reel;
determining a payout if the first reel symbol matches the second reel symbol and the first reel matches the second reel; and
providing the payout.

51. A method comprising:
receiving a first wager amount, in which the first wager amount is associated with a slot machine game;
receiving a second wager amount, in which the second wager amount is associated with a secondary wager;
receiving a first parameter identifying a first reel stop;
receiving a second parameter identifying a first reel symbol;
determining an outcome of the slot machine game, in which the outcome comprises a second reel symbol at a second reel stop;
determining whether the first reel symbol matches the second reel symbol;
determining whether the first reel stop matches the second reel stop;
determining a payout if the first reel symbol matches the second reel symbol and the first reel stop matches the second reel stop; and
providing the payout.

52. A method comprising:
receiving a first wager amount, in which the first wager amount is associated with a bonus game having a plurality of board game positions;
receiving a second wager amount, in which the second wager amount is associated with a secondary wager;
receiving a first parameter identifying a first board game position;
determining an outcome of the slot machine game, in which the outcome comprises a second board game position;
determining whether the first board game position matches the second board game position;
determining a payout if the first board game position matches the second board game position; and
providing the payout.

53. A gaming device comprising:
a processor; and
a memory coupled to the processor and storing instructions operative to:
provide a primary game;
receive a wager for a secondary game,
in which the wager indicates at least one parameter corresponding to a potential outcome of the secondary game;
determine an outcome of the secondary game; and
provide a payout for the secondary game.

54. A system comprising:
a controller; and
a gaming device in communication with the controller,
in which the controller is operative to:
provide a primary game at the gaming device;
receive a wager for a secondary game at the gaming device,
in which the wager indicates at least one parameter corresponding to a potential outcome of the secondary game;
determine an outcome of the secondary game; and
provide a payout for the secondary game.
